(19) United States
(12) Patent Application Publication
(10) Pub. No.: US 2025/0136756 A1
(43) Pub. Date: May 1, 2025

(54) PROCESS FOR THE SYNTHESIS OF POLYEPICHLOROHYDRIN

(71) Applicant: EURENCO, Sorgues (FR)

(72) Inventors: Geneviève ECK, Vedene (FR); Thibaud ALAIME, Vedene (FR); Sergei KOSTJUK, Minsk (BY); François GANACHAUD, Villeurbanne (FR); Guy JACOB, Vert le Petit (FR)

(73) Assignee: EURENCO, Sorgues (FR)

(21) Appl. No.: 18/694,107

(22) PCT Filed: Sep. 21, 2022
(86) PCT No.: PCT/FR2022/051775

§ 371 Date: Mar. 21, 2024

(30) Foreign Application Priority Data
Sep. 21, 2021 (FR) FR2109894

(51) Int. Cl. C08G 65/24; C08G 65/30

(52) U.S. Cl. CPC C08G 65/24; C08G 65/30; C08G 2650/22

(57) ABSTRACT

A method for synthesising polyepichlorohydrin including: a) reacting epichlorohydrin with boron trifluoroetherate in the presence of a polymerisation initiator; b) adding a good solvent for epichlorohydrin to the reaction product obtained in step a); c) adding epichlorohydrin to the reaction product obtained in step b).

### FIELD OF THE INVENTION

The invention relates to the field of energetic materials. More specifically, the invention concerns a process for synthesising a polyglycidyl azide intermediate, namely polyepichlorohydrin.

### STATE OF THE ART

With the aim of increasing the ballistic performance of tactical and strategic missiles, more energetic materials have been developed, in particular using glycidyl polyazide (GPA) to replace the inert binders historically used, such as hydroxyl-terminated polybutadiene (HTPB).

GPA can be produced in two steps, as shown in scheme 1 below, starting from epichlorohydrin (ECH) via polyepichlorohydrin (PECH), which is a dihydroxytelechelic polymer.

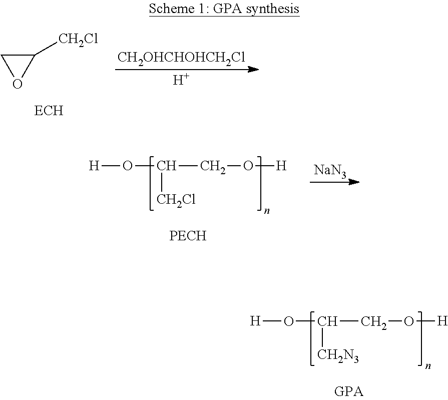

In the literature, there are three main methods of polymerising ECH to obtain PECH:
coordination polymerisation;
cationic polymerisation;
anionic polymerisation.

### Coordination Polymerisation

Catalytic ring-opening polymerisation of ECH was first described by Vandenberg [1-4] to synthesise PECHs with high molecular weights (Mn>50,000 g·mol⁻¹).

More recently other active species have been described such as bis(μ-oxo)dialkylaluminum [5]. Several other monometallic [6-8] and bimetallic catalyst systems have also been described, but again for the synthesis of high molecular weight PECHs.

Generally speaking, coordination polymerisation has a number of drawbacks from the point of view of understanding the mechanisms involved:
Catalytic systems and unsophisticated polymerisation procedures;
No data on polydispersity, functionality or structure;
Polymerisation mechanism unknown.

A more recent publication describes the solvent-free polymerisation of ECH in the presence of a specific catalyst [Zn—Co(III) DMCC: “Zinc cobalt(III) double metal cyanide complex”] as described in scheme 2 below. Yields ranged from 30 to 84% for number average masses of 900 g·mol⁻¹ to 4200 g·mol⁻¹ with, however, a high polydispersity of the order of 1.5.

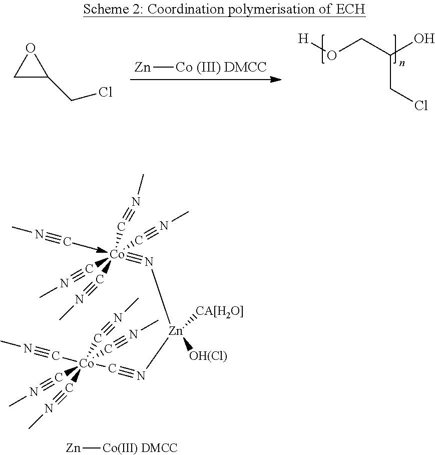

### Anionic Polymerisation

The controlled anionic polymerisation of ECH in the presence of Oct₄NBr/(iBu)₃ Al as initiator has been described by Carloti [11-12]. It has a number of advantages, including the use of a non-chlorinated solvent such as toluene. However, it also has one major drawback, which is the production of a monohydroxyl polymer, as shown in scheme 3 below.

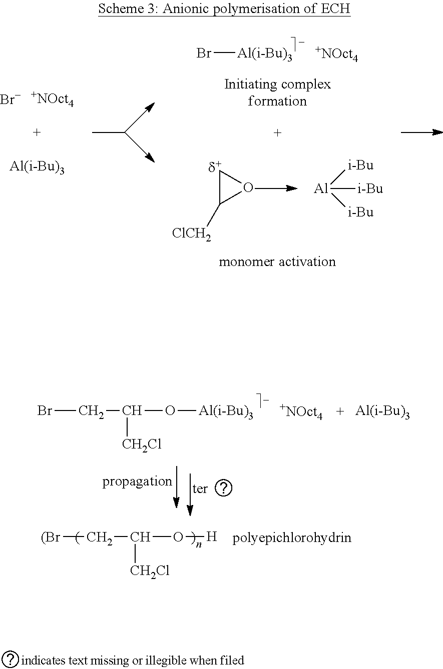

Very recently, direct polymerisation of glycidyl azide has been achieved using triethylborane combined with tetrabutylammonium bromide as a catalyst [13].

### Cationic Polymerisation

The data in the literature clearly show that coordination polymerisation and anionic polymerisation are not suitable for the synthesis of PECH, mainly because of a lack of control of the molecular mass and of a functionality which is very often far from the target value: 2.

In contrast, cationic ring-opening polymerisation with a diol as initiator leads to a dihydroxytelechelic polymer as shown in scheme 4.

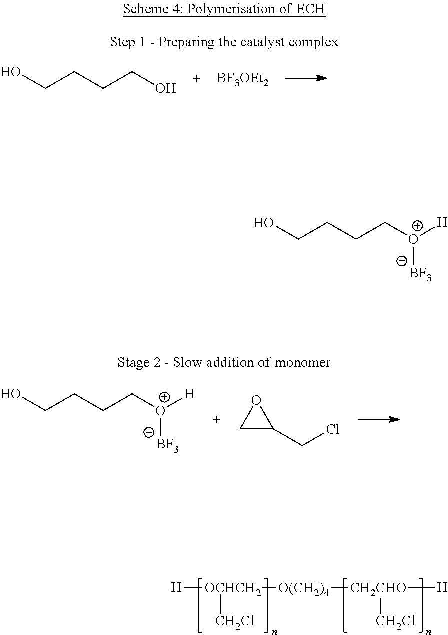

Polymerisation is often carried out in the presence of Lewis acids, such as boron trifluoroetherate (BF₃OEt₂) [14-18], tin tetrachloride (SnCl₄) [19], triethyloxonium hexafluorophosphate (Et₃O⁺PF⁶⁻) [20], 1,4-butanediyl ditriflate [21]. Triethyloxonium hexafluorophosphate leads to low molecular mass PECH (Mn<1,000 g·mol⁻¹), while butanediyl ditriflate leads to higher molecular mass PECHs (between 3,500 and 15,000 g·mol⁻¹) but in low yields.

Boron trifluoroetherate and tin tetrachloride are the most widely used, often combined with a diol as an initiator, with boron trifluoroetherate providing less polydisperse polymers than those obtained with tin tetrachloride.

Two patent applications [22,23] also describe the production of PECH by cationic polymerisation.

The solvents most commonly used for ECH polymerisation are chlorinated solvents, such as methylene chloride or 1,2-dichloroethane (DCE). The use of such solvents is affected by European regulation 1907/2006, better known as REACH (Registration, Evaluation, Authorisation and Restriction of Chemicals), which lists the substances whose use is subject to authorisation. For example, DCE has been included in Annex XIV of the REACH Regulation since 14 Aug. 2014, and can no longer be used in the absence of authorisation since 22 Nov. 2017. The obsolescence of DCE, and of other chlorinated solvents, is therefore foreseeable in the short to medium term.

Replacing chlorinated solvents in PECH synthesis therefore involves finding alternative synthesis routes that are compatible with current environmental and toxicological regulations, while maintaining the characteristics (number average mass Mn, weight average mass Mw and hydroxyl content) of the polymers currently produced and used on an industrial scale.

There are certainly examples of solvent-free cationic polymerisation of ECH described in the literature. The first example is the polymerisation of ECH in the presence of Bronsted acids such as acid clays [24]. In this case, polymerisation is carried out without solvent but the polymer obtained is bimodal, with a low molecular mass and a significant presence of cyclic by-products. In the second example, the reaction takes place in the presence of paratoluenesulphonic acid and tin tetrachloride. However, a major problem with this solvent-free route is the risk of losing control of the reaction.

None of the processes described in the literature is really satisfactory in terms of current regulations. Those that could be considered acceptable with regard to these regulations have low yields or lead to polymers whose physico-chemical characteristics are not in line with those of polymers currently produced on an industrial scale.

There is therefore a need for an alternative synthesis of PECH that is more environmentally friendly, compatible with current regulations and does not alter the physico-chemical properties of this product. It was with these specifications in mind that the present invention was developed.

### SUMMARY OF THE INVENTION

The invention relates to a process for the synthesis of polyepichlorohydrin which comprises:
a) reacting epichlorohydrin with boron trifluoroetherate [BF₃O(C₂H₅)₂] in the presence of a polymerisation initiator;
b) adding a good solvent for epichlorohydrin to the reaction product obtained in step a);
c) adding epichlorohydrin to the reaction product obtained in step b).

### DETAILED DESCRIPTION OF THE INVENTION

In the context of the present disclosure, the expression “reaction product” has the usual and common meaning used in chemical synthesis, namely a product which results from the reaction between at least two reactants which interact and are transformed into said product. Thus, the expression “reaction product obtained in step x” is equivalent to the expression “product obtained at the end of step x”. It will be further noted that when a process described in the present disclosure comprises a plurality of steps, each step is distinct. Thus, if a process comprises a step a) and a step b) involving “the reaction product obtained in step a)”, it goes without saying for the person skilled in the art that step b) cannot begin until step a) has been completed, i.e. the reagents have been consumed to form the “reaction product of step a)”.

The invention concerns a process for synthesising polyepichlorohydrin by suspension polymerisation. In such a process, the starting monomer is stabilised in microdroplets dispersed in a solvent. By way of example, the cationic polymerisation of vinyl monomers has been described in an aqueous medium [26].

In the context of the present invention, polymerisation proceeds essentially in three steps:

Step 1: initiation of polymerisation “directly” by bringing together epichlorohydrin, boron trifluoroetherate and a polymerisation initiator.

Step 2: addition of a good solvent for the epichlorohydrin and start of the propagation reaction by controlled addition of epichlorohydrin until a critical degree of polymerisation is reached, beyond which the polymer is no longer in solution but in suspension.

Step 3: suspension polymerisation continues with the controlled addition of epichlorohydrin.

Thus, the present invention relates to a process for the synthesis of polyepichlorohydrin which comprises:
a) reacting epichlorohydrin with boron trifluoroetherate in the presence of a polymerisation initiator;
b) adding a good solvent for epichlorohydrin to the reaction product obtained in step a);
c) adding epichlorohydrin to the reaction product obtained in step b).

In some embodiments, the polymerisation initiator is water, chloropropanediol or butanediol, preferably water.

In some embodiments, the good solvent for epichlorohydrin is a non-polar solvent such as a hydrocarbon. In some embodiments, the hydrocarbon is at least one compound selected from an alkane and a cycloalkane. In some embodiments, the hydrocarbon is selected from hexane, methylcyclohexane, dodecane, petroleum ether and mixtures of these compounds, preferably the hydrocarbon is methylcyclohexane.

In some embodiments, the reaction of step a) is carried out in the presence of substantially equimolar amounts of polymerisation initiator and epichlorohydrin. “Substantially equimolar” means that the molar ratio of polymerisation initiator to epichlorohydrin is between 0.90 and 1.10 (i.e. a deviation of 10% from equimolarity).

In some embodiments, the reaction in step a) is carried out in the presence of an excess of polymerisation initiator relative to boron trifluoroetherate.

In some embodiments, the reaction in step a) is carried out in the presence of a good solvent for epichlorohydrin, preferably the same good solvent as that used in step b).

In some embodiments, steps a) and b) are carried out simultaneously.

Step c) involves the controlled addition of epichlorohydrin to the reaction product obtained in step b). It has been found that the speed and duration of the addition of epichlorohydrin make it possible to control the exothermicity of the reaction and the characteristics of the final polymer (polydispersity, presence or absence of macrocycles in greater or lesser amounts, . . . ).

Suspension polymerisation makes it possible to obtain PECHs with controlled molar masses (between 850 g·mol⁻¹ and 4,000 g·mol⁻¹) that correlate perfectly with theory, and with a low polydispersity of 1.25 or less.

The process according to the invention also has an advantage in terms of scaling up (pilot and/or industrial scale). The ring-opening polymerisation conditions described in the literature on a laboratory scale (a few grams of monomer) often mean that the polymers obtained on a larger scale have degraded characteristics in terms of Mn, polydispersity and functionality, or that the exothermicity of the reaction is more difficult to control. The process described here can be extrapolated to more than a hundred grams of monomer without any impact on the characteristics of the polymer.

In summary, the suspension polymerisation process used in this invention provides very good control of polymerisation and offers many advantages:
perfect control of the temperature exotherm often observed during ring-opening cationic polymerisation;
polymerisation using solvents that are less toxic than the chlorinated solvents commonly used for ring-opening cationic polymerisation;
polymerisation time (around 6 to 7 hours) compatible with industrial scale;
polymerisation yields in excess of 90%, comparable to industrial-scale yields of around 95%;
obtaining a monomodal polymer with perfectly controlled Mn (from 850 to 4,000 g·mol⁻¹) with a functionality in line with theory, to be compared with a functionality of 1.4 to 1.6 for a PECH produced, to date, on an industrial scale;
low polydispersity, less than or equal to 1.25, which is therefore comparable to the values measured on an industrial PECH.

It is also possible to recycle the good solvent used in step b).

According to some embodiments, the method of the invention further comprises:
d) decanting the product obtained in step c), followed by separating the polyepichlorohydrin and recovering the residual good solvent.

According to some embodiments, the recovered solvent is reused in step b) or, as indicated above, in steps a) and b) combined when these are carried out simultaneously. The invention will be better understood with the aid of the following examples, given by way of illustration. In these examples, the number average molar mass (Mn) and weight average molar mass (Mw) of polyepichlorohydrin were determined either by NMR or by steric exclusion chromatography (SEC) under the following conditions:

### NMR

¹H NMR (500 MHZ) in CDCl₃ at 25° C. on a Bruker AC-500

### SEC

Equipment: Ultimat 3000 Thermo Scientific with an Agilent PLgel 5 μm MIXED-C column (300×7.5 mm) and a precolumn (PL gel 5 μm 50×7.5 mm) thermostated at 30° C.
Detection: refractometry and UV.
Eluent: THF, 1.0 ml/min.
Standard: polystyrene.

The polydispersity Ð of polyepichlorohydrin is equal to the ratio Mp/Mn.

The functionality is calculated according to the formula: [Mn(SEC)/Mn(NMR)]×2.

The formulae BF₃O(C₂H₅)₂ and BF₃OEt₂ are used interchangeably to designate boron trifluoroetherate (also known as boron trifluoride dietherate).

### Example 1

0.48 mL (6.12×10⁻³ mol) of ECH, 0.046 mL (3.72×10⁻⁴ mol) of BF₃O(C₂H₅)₂ and 0.1 mL (5.56×10⁻³ mol) of H₂O were added to a round-bottom flask. The reaction mixture was stirred for 1.5 h at 25° C. until a clear viscous liquid formed. Next, 17 mL of methyl cyclohexane were added to the flask, followed by the addition of 8.1 mL (0.1 mol) of ECH via a syringe pump, controlling the rate of addition to control the exothermicity of the reaction.

After all the ECH had been added, the reaction mixture was stirred for 1 h, and the PECH was recovered after decantation and vacuum drying at 60° C. to constant weight.

PECH was purified by dissolving in toluene, washing with an aqueous sodium bicarbonate solution and then with water, evaporating the solvent under reduced pressure and drying the polymer to constant weight. 10 g of PECH were thus obtained.

Yield=100%; Mn (NMR)=1,375 g·mol⁻¹; Mn (SEC)=1,480 g·mol⁻¹; Ð=1.14; Functionality=2.

### Example 2

3.2 mL (4.08×10⁻² mol) of ECH, 0.32 mL (2.69×10⁻³ mol) of BF₃OEt₂, 0.7 mL (3.85×10⁻² mol) of H₂O and 3.2 mL of methyl cyclohexane were added to a round-bottom flask. The reaction mixture was stirred for 1.5 h at 25° C. until a clear viscous liquid formed. Next, 160 mL of methyl cyclohexane were added to the reactor followed by the addition of 81.3 mL (1.04 mol) of ECH at a controlled rate to control the exothermicity of the reaction. After all the ECH had been added, the reaction mixture was stirred for 1.5 h. The PECH was recovered and purified according to the procedure in Example 1. 94 g of PECH were thus obtained.

Yield=95%; Mn (NMR)=2,420 g·mol⁻¹; Mn (SEC)=2,670 g·mol⁻¹; Ð=1.22; Functionality=2.

### Example 3

The procedure in Example 1 was repeated, but with molar ratios of [ECH]/[H₂O]=27 and [H₂O]/[BF₃OEt₂]=15, and varying the nature of the good solvent for the epichlorohydrin. The results are shown in the table below.

TABLE 1

| | Yield | Mn NMR | Mn SEC | | |
|---|---|---|---|---|---|
| Solvent | (%) | (g · mol₋₁) | (g · mol₋₁) | Ð | Functionality |
| Methylcyclohexane | 100 | 2,120 | 2,370 | 1.19 | 2 |
| Hexane | 100 | 3,080 | 2,480 | 1.20 | 2 |
| Dodecane | 98 | 2,190 | 2,460 | 1.19 | 2 |
| Petroleum ether | 100 | 2,260 | 2,290 | 1.20 | 2 |

### BIBLIOGRAPHIC REFERENCES

1) Vandenberg, E. J. Award Address, Polymer 1994, 35, 4933-4939
2) Vandenberg, E. J. Organometallic Catalysts for Polymerizing Monosubstituted Epoxides. J. Polym. Sci. 1960, 47, 486-489
3) Vandenberg, E. J. Epoxide Polymers: Synthesis, Stereochemistry, Structure, and Mechanism. J. Polym. Sci. Part A: Polym. Chem. 1969, 7, 525-567
4) Brochu, S.; Ampleman, G. Synthesis and Characterization of Glycidyl Azide Polymers Using Isotactic and Chiral Poly(epichlorohydrin)s. Macromolecules 1996, 29, 5539-5545.
5) Ferrier Jr, R. C.; Pakhira, S.; Palmon, S. E.; Rodriguez, C. G.; Goldfeld. D. E.; Iyiola, O. O.; Chwatko, M.; Mendoza-Cortes, J. L.; Lynd, N. A. Demystifying the Mechanism of Regio- and Isoselective Epoxide Polymerization Using the Vandenberg Catalyst. Macromolecules 2018, 51, 1777-1786.
6) Masuda, Y.; Hani, H. Organoaluminum—Cyclic Ether—Cyclic Imide Catalysts for the Polymerization of Epoxides. J. Polym. Sci.: Polym. Chem. Ed. 1973, 11, 3103-3114.
7) Araki, T.; Aoyagi, T.; Ueyama, N.; Aoyama, T.; Tani, H. Ethylaluminum Oxide Catalysts from Et2AlOLi-Et2AlCl Binary System in Relation to Species of AlEt3—Water Catalyst. J. Polym. Sci. Part A: Polym. Chem. 1973, 11, 699-712;
8) Xie, H-Q.; Guo, J-S.; Yu, G.-Q.; Zu, J. Ring-Opening Polymerization of Epichlorohydrin and its Copolymerization with other Alkylene Oxides by Quaternary Catalyst System. J. Appl. Polym. Sci. 2001, 80, 2446-2454.
9) Kuntz, I.; Kroll, W. R. Polymerization of Epoxides with Dialkylaluminum Acetylacetonate Catalyst Systems J. Polym. Sci. part A: Polym. Chem. 1970, 8, 1601-1621.
10) Rodriguez, C. G.; Ferrier Jr, R. C.; Helenic, A.; Lynd, N. A. Ring-Opening Polymerization of Epoxides: Facile Pathway to Functional Polyethers via a Versatile Organoaluminum Initiator. Macromolecules 2017, 50, 3121-3130.
11) Carlotti, S.; Labbe, A.; Rejsek, V.; Doutaz, S.; Gervais, M.; Deffieux, A. Living/Controlled Anionic Polymerization and Copolymerization of Epichlorohydrin with Tetraoctylammonium Bromide-Triisobutylaluminum Initiating Systems. Macromolecules 2008, 41, 7058-7062.
12) Brocas, A-L.; Cendejas. G.; Caillol, S.; Deffieux, A.; Carlotti, S. Controlled Synthesis of Polyepichlorohydrin with Pendant Cyclic Carbonate Functions for Isocyanate-Free Polyurethane Networks. J. Polym. Sci. Part A: Polym. Chem. 2011, 49, 2677-2684
13) Boopathi, S. K.; Hadjichristidis, N.; Gnanou, Y.; Feng, X. Direct Access to Poly(glycidyl azide) and its Copolymers through Anionic (Co-)Polymerization of Glycidyl Azide. Nature Communications 2019, 10, 293.
14) Bideron, T.; Kubisa, P.; Penczek, S. Polyepichlorohydrin Diols Free of Cycles: Synthesis and Characterization. J. Polym. Sci. Part A: Polym. Chem. 1991, 29, 619-628
15) Panda, S. P.; Sahu, S. K.; Thakur, J. V.; Kulkarni, S. G.; Kumbhar, C. G.; Sadafule, D. S. Synthesis and Characterization of Hydroxyl Terminated Polyepichlorohydrin and Polyglycidylazide. Def. Sci. J. 1996, 46, 399-403.
16) Kim, J. S.; Kweon, J. O.; Noh, S. T. Online Monitoring of Reaction Temperature during Cationic Ring Opening Polymerization of Epichlorohydrin in Presence of BF3 and 1,4-Butanediol. J. Appl. Polym. Sci. 2014, 131, 39912
17) Guanaes, D.; Bittencourt, E.; Eberlin, M. N.; Sabino, A. A. Influence of Polymerization Conditions in the Molecular Weight and Polydispersity of Polyepichlorohydrin. Eur. Polym. J. 2007, 43, 2141-2148
18) Grinevich, T. V.; Solov'yanov, A. A.; Vinogradov, D. B.; Bulatov, P. V.; Kuznetsov, G. P.; Assovskii, I. G.; Berlin, A. A.; Tartakovskii, V. A. Oligo(glycidyl azides): New Approaches to Synthesis and Properties. Dokl. Chem. 2014, 454, 39-41
19) Francis, A. U.; Venkatachalam, S.; Kanakavel, M.; Ravindran, P. V.; Ninan, K. N. Structural Characterization of Hydroxyl Terminated Polyepichlorohydrin Obtained using Boron Trifluoride Etherate and Stannic Chloride as Initiators. Eur. Polym. J. 2003, 39, 831-841.
20) Okamoto, Y. Cationic Ring-Opening Polymerization of Epichlorohydrin in the Presence of Ethylene Glycol. ACS Symp. Ser. 1985, 286, 361-372
21) Kim, C. S.; Kuo, K.; Fish, R.; Russell, J.; Curb, P.; Immoos, J. Telechelic Polymerization of Epichlorohydrin using 1,4-Butanediyl Ditriflate as the Initiator. Macromolecules 1990, 23, 4715-4717
22) FR 2 638 751 A1
23) FR 2 633 300 A1
24) Yahiaoui, A.; Belbachir, M.; Hachemaoui, A. An Acid Exchanged Montmorillonite Clay-Catalyzed Synthesis of Polyepichlorhydrin. Int. J. Mol. Sci. 2003, 4, 548-561
25) Muhammad Ahmad, Muhammad Sirajuddin, Zareen Akther, Waqar Ahmad, Spectrochim. Acta Part A: Mol. Biomol. Spectro. 2015, 151, 164-173
26) S. V. Kostjuk, F. Ganachaud, Cationic Polymerization of Vinyl Monomers in Aqueous Media: From Monofunctional Oligomers to Long-Lived Polymer Chains, Accounts of Chemical Research, 2010, Vol. 43 N°3, 357-367

1. A process for the synthesis of polyepichlorohydrin which comprises:
a) reacting epichlorohydrin with boron trifluoroetherate in the presence of a polymerisation initiator;
b) adding a good solvent for epichlorohydrin to the reaction product obtained in step a);
c) adding epichlorohydrin to the reaction product obtained in step b).

2. The process of claim 1, wherein the polymerisation initiator is water.

3. The process of claim 1, wherein the good solvent for epichlorohydrin is a hydrocarbon.

4. The process of claim 3, wherein the hydrocarbon is at least one compound selected from an alkane and a cycloalkane.

5. The process of claim 4, wherein the hydrocarbon is selected from hexane, methylcyclohexane, dodecane, petroleum ether and mixtures of these compounds.

6. The process of claim 1, wherein the reaction of step a) is carried out in the presence of substantially equimolar amounts of polymerisation initiator and epichlorohydrin.

7. The process of claim 1, wherein the reaction of step a) is carried out in the presence of an excess of polymerisation initiator relative to boron trifluoroetherate.

8. The process of claim 1, wherein the reaction of step a) is carried out in the presence of a good solvent for epichlorohydrin.

9. The process of claim 1, wherein steps a) and b) are carried out simultaneously.

10. The process of claim 1, which further comprises:
d) decanting the product obtained in step c), followed by separating the polyepichlorohydrin and recovering the residual good solvent.

11. The process of claim 10, wherein the recovered solvent is reused in the process of steps a) to c).
